(19) United States
(12) Patent Application Publication
(10) Pub. No.: US 2012/0254580 A1
(43) Pub. Date: Oct. 4, 2012

(54) ACCESS CONTROL APPARATUS

(75) Inventor: Takahiro Miomo, Higashiosaka-shi (JP)

(73) Assignee: Sanyo Electric Co., Ltd., Osaka (JP)

(21) Appl. No.: 13/426,695

(22) Filed: Mar. 22, 2012

(30) Foreign Application Priority Data
Apr. 1, 2011 (JP) 2011-081365

(51) Int. Cl. G06F 12/02

(52) U.S. Cl. 711/173; 711/E12.002

(57) ABSTRACT

An access control apparatus includes an accessor. An accessor accesses a recording medium in which a plurality of partitions are formed. A elector selects any one of a first mode and a second mode. A designator designates at least a part of the plurality of partitions in a manner different depending on a mode selected by the selector. A controller controls a processing operation of the accessor with reference to identification information of the partition designated by the designator, when the mode selected by the selector is the first mode. A sender sends the identification information of the partition designated by the designator in order for an external device to refer, when the mode selected by the selector is the second mode.

### CROSS REFERENCE OF RELATED APPLICATION

The disclosure of Japanese Patent Application No. 2011-81365, which was filed on Apr. 1, 2011, is incorporated herein by reference.

### BACKGROUND OF THE INVENTION

1. Field of the Invention

The present invention relates to an access control apparatus. More particularly, the present invention relates to an access control apparatus which controls an access operation to a recording medium in which a plurality of partitions are formed.

2. Description of the Related Art

According to one example of this type of apparatus, the recording medium is detachably attached to a memory slot of a target device. Information (a program and data) for displaying an operation manual of the target device is recorded, by a system which is based on a bidirectional and viewpoint-steerable display of a three-dimensional moving-image (animation), on a part of a storage region of the recording medium before shipment.

However, in the above-described apparatus, information capable of being read out from the recording medium is common irrespective of an attribute of a device of an access resource. In other words, it is impossible to change the information to be contained in the recording medium corresponding to the attribute of the access resource. Thus, in the above-described apparatus, a diversity of the information to be contained in the recording medium is limited.

### SUMMARY OF THE INVENTION

An access control apparatus according to the present invention comprises: an accessor which accesses a recording medium in which a plurality of partitions are formed; a selector which selects any one of a first mode and a second mode; a designator which designates at least a part of the plurality of partitions in a manner different depending on a mode selected by the selector; a controller which controls a processing operation of the accessor with reference to identification information of the partition designated by the designator, when the mode selected by the selector is the first mode; and a sender which sends the identification information of the partition designated by the designator in order for an external device to refer, when the mode selected by the selector is the second mode.

According to the present invention, an access control program recorded on a non-transitory recording medium in order to control an access control apparatus provided with an accessor which accesses a recording medium in which a plurality of partitions are formed and a selector which selects any one of a first mode and a second mode, the program causing a processor of the access control apparatus to perform the steps comprises: a designating step of designating at least a part of the plurality of partitions in a manner different depending on a mode selected by the selector; a controlling step of controlling a processing operation of the accessor with reference to identification information of the partition designated by the designating step, when the mode selected by the selector is the first mode; and a sending step of sending the identification information of the partition designated by the designating step in order for an external device to refer, when the mode selected by the selector is the second mode.

According to the present invention, an access control method executed by an access control apparatus provided with an accessor which accesses a recording medium in which a plurality of partitions are formed and a selector which selects any one of a first mode and a second mode, comprises: a designating step of designating at least a part of the plurality of partitions in a manner different depending on a mode selected by the selector; a controlling step of controlling a processing operation of the accessor with reference to identification information of the partition designated by the designating step, when the mode selected by the selector is the first mode; and a sending step of sending the identification information of the partition designated by the designating step in order for an external device to refer, when the mode selected by the selector is the second mode.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of a NAND-type flash memory;

FIG. 4(A) is an illustrative view showing one example of a setting state of a register when a camera mode or a reproducing mode is selected;

FIG. 4(B) is an illustrative view showing one example of a setting state of the register when a USB communication mode is selected;

FIG. 5(A) is an illustrative view showing one example of a mapping state of the NAND-type flash memory recognized by a CPU of the embodiment in FIG. 2 when an imaging task or a reproducing task is activated;

FIG. 5(B) is an illustrative view showing one example of a mapping state of the NAND-type flash memory recognized by a CPU of an external personal computer when a USB communication task is activated;

FIG. 6 is a block diagram showing one example of a configuration of the external personal computer connected to the embodiment in FIG. 2;

FIG. 7 is an illustrative view showing one example of a display of a display monitor arranged in the external personal computer;

FIG. 8 is a flowchart showing one portion of behavior of the CPU applied to the embodiment in FIG. 2;

FIG. 9 is a flowchart showing another portion of behavior of the CPU applied to the embodiment in FIG. 2;

FIG. 10 is a flowchart showing still another portion of behavior of the CPU applied to the embodiment in FIG. 2;

FIG. 11 is a flowchart showing yet another portion of behavior of the CPU applied to the embodiment in FIG. 2;

FIG. 12 is a flowchart showing another portion of behavior of the CPU applied to the embodiment in FIG. 2; and

FIG. 13 is a flowchart showing still another portion of behavior of the CPU applied to the embodiment in FIG. 2.

### DETAILED DESCRIPTION OF THE PREFERRED EMBODIMENTS

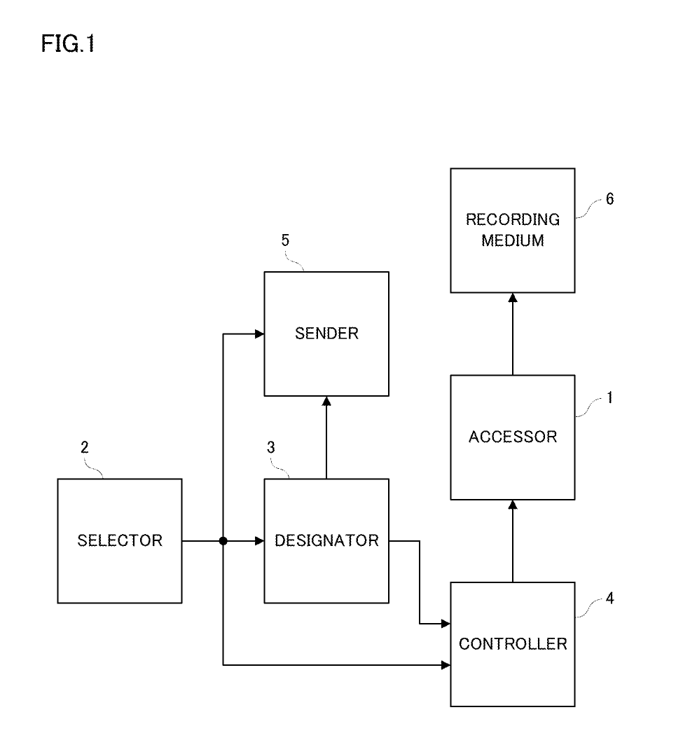

With reference to FIG. 1, an access control apparatus according to one embodiment of the present invention is basically configured as follows: An accessor 1 accesses a recording medium 6 in which a plurality of partitions are formed. A elector 2 selects any one of a first mode and a second mode. A designator 3 designates at least a part of the plurality of partitions in a manner different depending on a mode selected by the selector 2. A controller 4 controls a processing operation of the accessor 1 with reference to identification information of the partition designated by the designator 3, when the mode selected by the selector 2 is the first mode. A sender 5 sends the identification information of the partition designated by the designator 3 in order for an external device to refer, when the mode selected by the selector 2 is the second mode.

A designating manner of the plurality of partitions formed in the recording medium 6, by extension, information read out from the recording medium 6 is different depending on when the first mode is selected or when the second mode is selected. Thereby, it becomes possible to improve a diversity of the information to be contained in the recording medium 6.

Moreover, the identification information of the designated partition is referred to by the internal controller 4 when the first mode is selected whereas is sent in order for the external device to refer, when the second mode is selected. Thereby, it becomes possible to reduce a load imposed on an access process under the second mode.

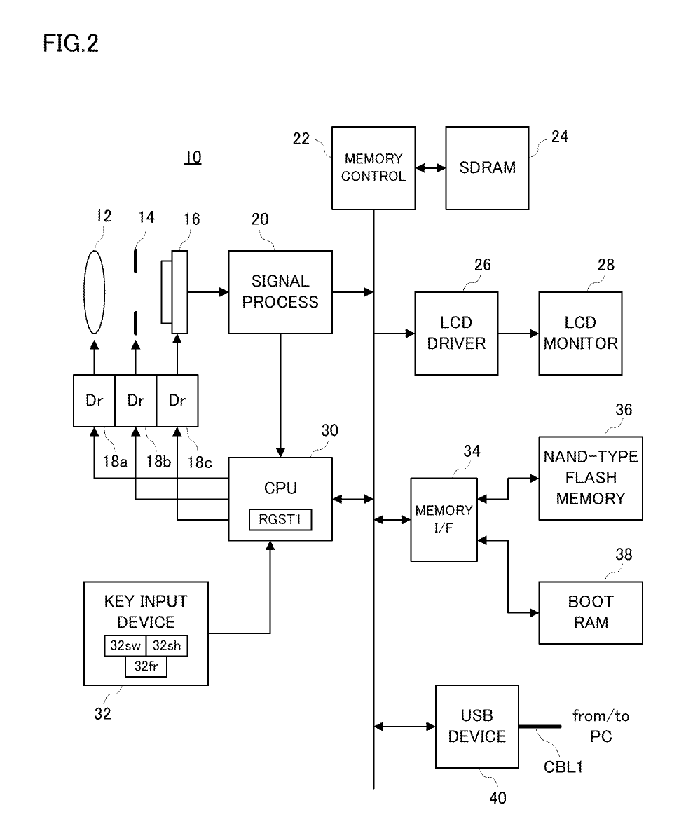

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an imager 16, and is subjected to a photoelectric conversion.

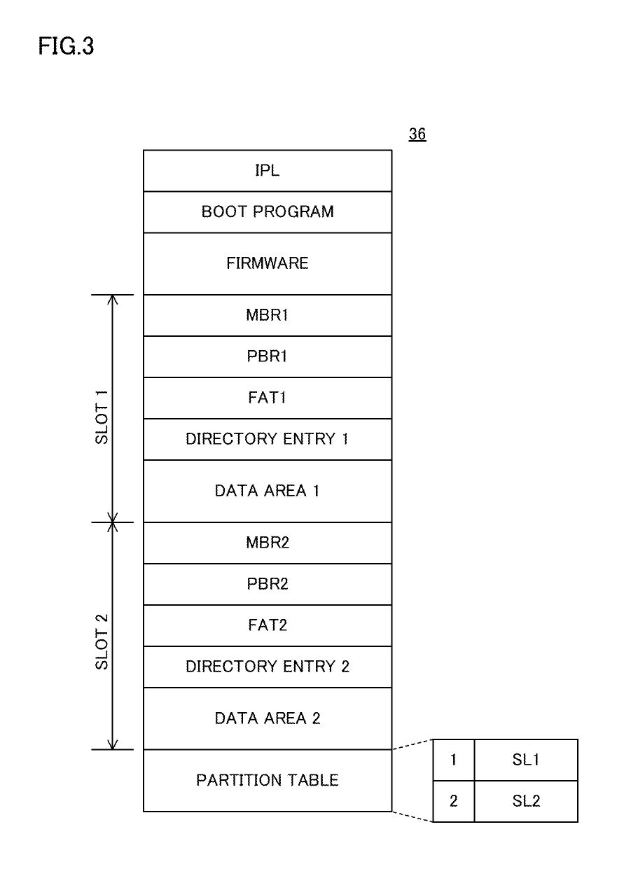

When a power source is applied, firstly, a NAND-type flash memory 36 is accessed by a memory I/F 34. With reference to FIG. 3, the flash memory 36 has an IPL (Initial Program Loader), a boot program for firmware, firmware, slots 1 and 2 and a partition table. Specifically, the slot 1 is arranged in a position adjacent to the firmware. Here, the slot has the same meaning as the “partition”. Moreover, as the firmware, an OS (Operating System) which conforms to the μ IRON and a plurality of tasks (details are described later) executed under the OS are assumed.

The slot 1 is formed by an MBR 1 (MBR: Master Boot Record), a PBR 1 (PBR: Partition Boot Record), an FAT 1 (FAT: File Allocation Table), a directory entry 1 and a data area 1. The slot 2 is formed by an MBR 2, a PBR 2, an FAT 2, a directory entry 2 and a data area 2.

A mapping state of the slot 1 is recognized by referring to the MBR 1, and a mapping state of the slot 2 is recognized by referring to the MBR 2. Moreover, the data area 1 is equivalent to an area for storing an operation manual file (a file in which operation manual data is contained) of the digital camera 10, and the data area 2 is prepared in order to store an image file (a file in which image data representing a scene captured on the imaging surface is contained).

Furthermore, attribute information indicating file attributes such as a file name of the operation manual file stored in the data area 1, a file size, file-creation date and time and etc. is described in the directory entry 1, and link information indicating a link among a plurality of clusters in which the operation manual files are written is described in the FAT 1. Similarly, attribute information indicating attributes of the image files stored in the data area 2 is described in the directory entry 2, and link information indicating a link among a plurality of clusters in which the image files are written is described in the FAT 2.

The partition table is formed by a column 1 in which a slot number SL1 identifying the slot 1 is described and a column 2 in which a slot number SL2 identifying the slot 2 is described. That is, an order of slot numbers arrayed in the partition table matches an order of an array of the slots 1 and 2, and a column number and a slot number corresponding to each other indicate a common numerical value.

The memory I/F 34 reads out the IPL from the flash memory 36 thus configured so as to write the read-out IPL into a boot RAM 38. Moreover, a CPU 30 activated by applying the power source reads out the firmware stored in the flash memory 36 with reference to the IPL stored in the boot RAM 38 so as to write the read-out firmware into an SDRAM 24 through a memory control circuit 22. Thereafter, the CPU 30 executes the firmware stored in the SDRAM 24. It is noted that the boot program stored in the flash memory 36 is used only in emergency.

Under the activated firmware, the CPU 30 executes a main task. In the main task, a setting (i.e., an operation mode at a current time point) of a mode selector switch 32sw arranged in a key input device 32 is determined, so as to activate a task corresponding to the operation mode at the current time point. When the operation mode at the current time point is a camera mode, an imaging task is activated, and when the operation mode at the current time point is a reproducing mode, a reproducing task is activated. Moreover, when the operation mode at the current time point is a USB communication mode, a USB communication task is activated.

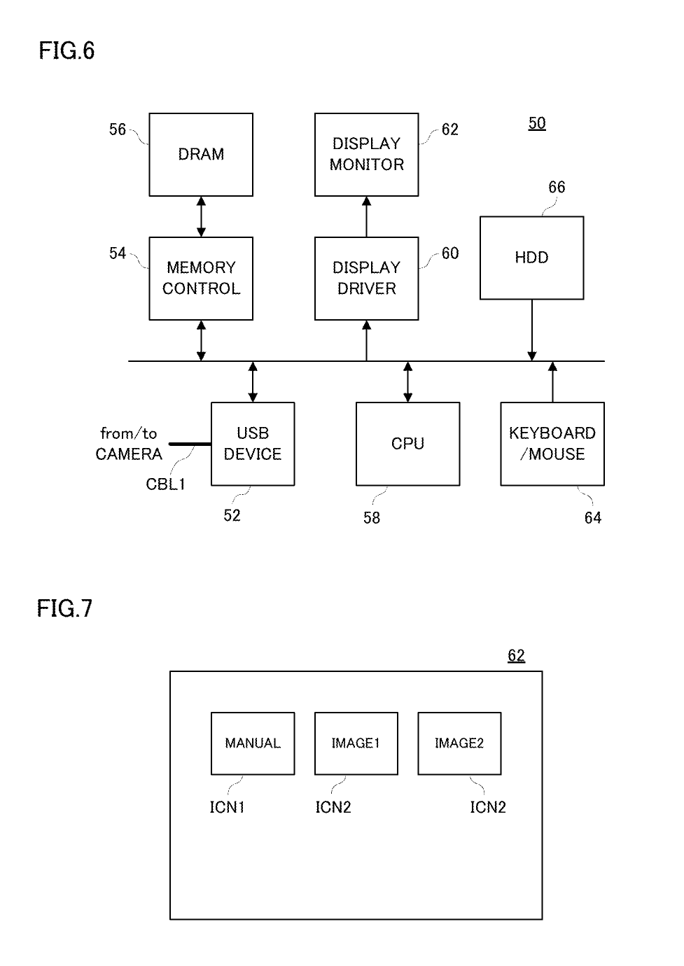

It is noted that, the USB communication mode is assumed that one end of a USB cable CBL1 is attached to a USB device 40 of the digital camera 10 and the other end of the USB cable CBL1 is attached to a USB device 52 of an external personal computer 50 shown in FIG. 6.

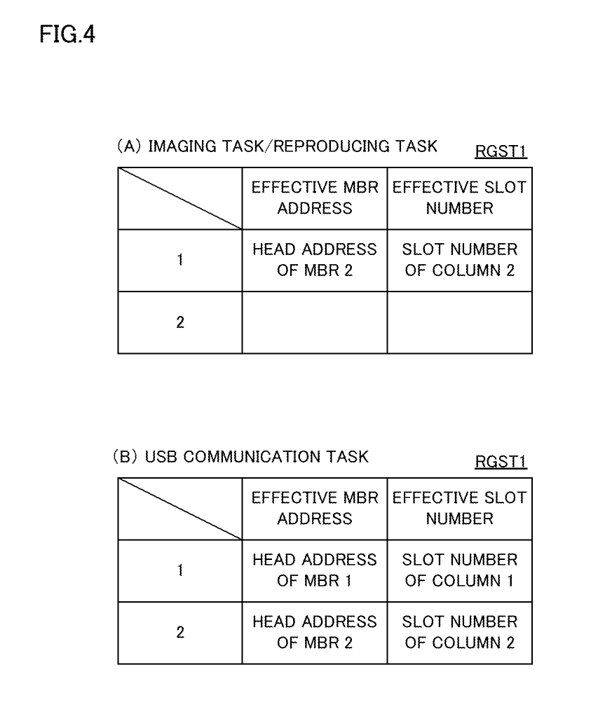

Moreover, in the main task, along with the imaging task or the reproducing task being activated, a head address of the MBR 2 is set to the column 1 of a register RGST1 as an effective MBR address, and the slot number described in the column 2 of the partition table is set to the column 1 of the register RGST1 as an effective slot number (see FIG. 4(A)).

Furthermore, in the main task, along with the USB communication task being activated, a head address of the MBR 1 and the head address of the MBR 2 are respectively set to the columns 1 and 2 of the register RGST1 as the effective MBR address, and the slot numbers described in the columns 1 and 2 of the partition table are respectively set to the columns 1 and 2 of the register RGST1 as the effective slot number (see FIG. 4(B)).

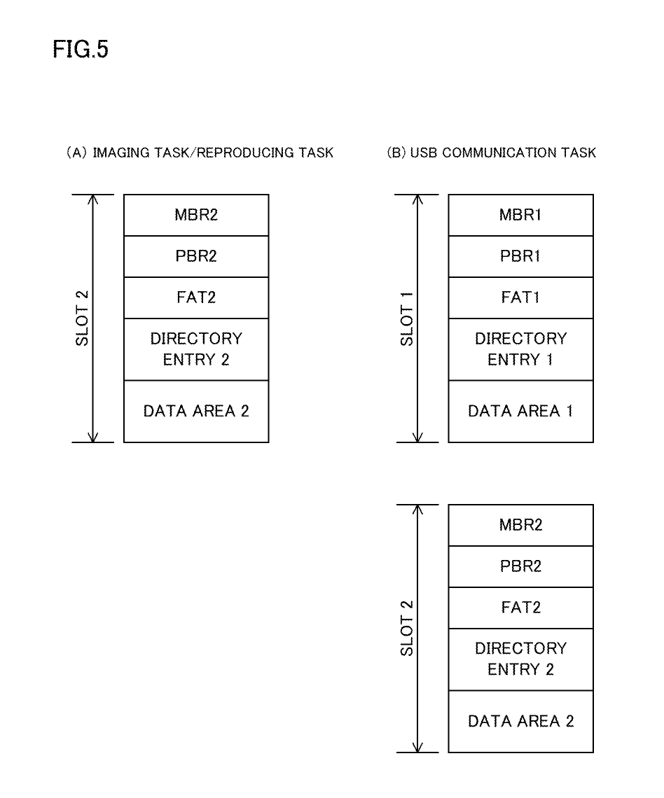

Each of the activated imaging task and reproducing task refers to the setting of the register RGST1, i.e., refers to descriptions of boot records starting from the effective MBR address, so as to recognize a mapping state of the flash memory 36. Thus, under the imaging task and the reproducing task, the flash memory 36 is recognized as having a mapping shown in FIG. 5(A).

When the imaging task is activated, the CPU 30 commands a driver 18c to repeat an exposure procedure and an electric-charge reading-out procedure in order to execute a moving-image taking process. In response to a vertical synchronization signal Vsync that is cyclically generated, the driver 18c exposes the imaging surface of the imager 16 and reads out electric charges produced on the imaging surface in a raster scanning manner. From the imager 16, raw image data based on the read-out electric charges is cyclically outputted.

A signal processing circuit 20 performs processes, such as white balance adjustment, color separation, and YUV conversion, on the raw image data outputted from the imager 16, and writes YUV formatted-image data produced thereby, into the SDRAM 24 through the memory control circuit 22. An LCD driver 26 repeatedly reads out the image data stored in the SDRAM 24 through the memory control circuit 22, and drives an LCD monitor 28 based on the read-out image data. As a result, a real-time moving image (a live view image) representing the scene captured on the imaging surface is displayed on a monitor screen.

Out of the image data produced by the signal processing circuit 20, Y data is applied also to the CPU 30. The CPU 30 performs a simple AE process on the applied Y data so as to calculate an appropriate EV value. An aperture amount and an exposure time period defining the calculated appropriate EV value are respectively set to the drivers 18b and 18c, and as a result, a brightness of the live view image is adjusted approximately.

When a shutter button 32sh is half depressed, the CPU 30 performs a strict AE process on the Y data applied from the signal processing circuit 20 so as to calculate an optimal EV value. Similarly to the above-described case, an aperture amount and an exposure time period defining the calculated optimal EV value are respectively set to the drivers 18b and 18c. As a result, the brightness of the live view image is adjusted strictly. Moreover, the CPU 30 performs an AF process on a high-frequency component of the Y data applied from the signal processing circuit 20. Thereby, the focus lens 12 is placed at a focal point, and thus, a sharpness of the live view image is improved.

When the shutter button 32sh is fully depressed, the CPU 30 commands the memory I/F 34 to execute a recording process. The memory I/F 34 reads out one frame of image data representing a scene captured at a time point at which the shutter button 32sh is operated, from the SDRAM 24 through the memory control circuit 22, and writes an image file containing the read-out image data into the data area 2 of the flash memory 36. Furthermore, in association with the writing process, the memory I/F 34 describes the attribute information of the image file in the directory entry 2 and updates the FAT 2 so that the link is formed among the plurality of clusters in which the image files are written.

When the reproducing task is activated, the CPU 30 detects the latest image file stored in the data area 2 with reference to the directory entry 2, and commands the memory I/F 34 and the LCD driver 26 to execute a reproducing process in which the detected image file is noticed. The memory I/F 34 reads out image data of a designated image file with reference to the FAT 2 so as to write the read-out image data into the SDRAM 24 through the memory control circuit 22.

The LCD driver 26 reads out the image data stored in the SDRAM 24, through the memory control circuit 22 so as to drive the LCD monitor 28 based on the read-out image data. As a result, a reproduced image based on the image data of the designated image file is displayed on the LCD monitor 28.

When a forward/backward button 32fr of the key input device 32 is operated, the CPU 30 refers to the directory entry 2 so as to detect a succeeding image file or a preceding image file from the data area 2. The detected image file is subjected to the reproducing process similar to that described above and as a result, the reproduced image is updated.

When the USB communication task is activated in a state where the digital camera 10 and the external personal computer 50 are connected to each other by the USB cable CBL1, the CPU 30 transfers registration information of the register RGST1, i.e., the effective MBR address and the effective slot number to the external personal computer 50 through the USB device 40. The USB communication task is ended after completion of transferring the registration information.

With reference to FIG. 6, the registration information transferred from the digital camera 10 is taken by the USB device 52 so as to be written into a DRAM 56 through a memory control circuit 54. A CPU 58 recognizes the mapping state of the flash memory 36 with reference to the registration information thus acquired. The flash memory 36 is recognized as having a mapping shown in FIG. 5(B).

Subsequently, the CPU 58 issues a corresponding command toward the digital camera 10 in order to detect attributes of the files stored in the recognized slots 1 and 2. The issued command is applied to the memory I/F 34 through the USB device 52, the USB cable CBL1 and the USB device 40. The memory I/F 34 reads out the attribute information of the file stored in the slot 1 from the directory entry 1, reads out the attribute information of the file stored in the slot 2 from the directory entry 2, and then sends back the read-out attribute information to the external personal computer 50.

The attribute information is written into the DRAM 56 by the memory control circuit 54 via the USB device 40, the USB cable CBL1 and the USB device 52. A display driver 60 reads out the attribute information thus acquired through the memory control circuit 54 so as to drive a display monitor 62 based on the read-out attribute information. As a result, a corresponding icon is displayed on the monitor screen.

As described above, the operation manual file is stored in the data area 1 of the slot 1, and one or at least two image files are stored in the data area 2 of the slot 2. Thus, an icon ICN1 indicating the operation manual file and an icon ICN2 individually indicating the one or at least two image files are displayed on the monitor screen as shown in FIG. 7.

When the icon ICN2 is clicked by a keyboard/mouse 64, it is regarded that an image acquiring operation is performed. The CPU 58 issues a corresponding command toward the digital camera 10 in order to acquire image data corresponding to the clicked icon IC2 from the flash memory 36. The issued command is applied to the memory I/F 34 through the USB device 52, the USB cable CBL1 and the USB device 40. The memory I/F 34 reads out the desired image data from the data area 2 with reference to the FAT 2 so as to send back the read-out image data to the external personal computer 50.

The image data is written into the DRAM 56 by the memory control circuit 54 via the USB device 40, the USB cable CBL1 and the USB device 52. The display driver 60 reads out the image data thus acquired through the memory control circuit 54 so as to drive the display monitor 62 based on the read-out image data. As a result, a corresponding image is displayed on the monitor screen.

When the icon ICN1 is clicked by the keyboard/mouse 64, it is regarded that a manual acquiring operation is performed. The CPU 58 issues a corresponding command toward the digital camera 10 in order to acquire operation manual data. Similarly to the above-described case, the issued command is applied to the memory I/F 34 through the USB device 52, the USB cable CBL1 and the USB device 40.

The memory I/F 34 reads out the operation manual data from the data area 1 with reference to the FAT 1 so as to send back the read-out operation manual data to the external personal computer 50. The operation manual data is written into the DRAM 56 by the memory control circuit 54 via the USB device 40, the USB cable CBL1 and the USB device 52. The display driver 60 reads out the operation manual data thus acquired through the memory control circuit 54 so as to drive the display monitor 62 based on the read-out operation manual data. As a result, an operation manual is displayed on the monitor screen.

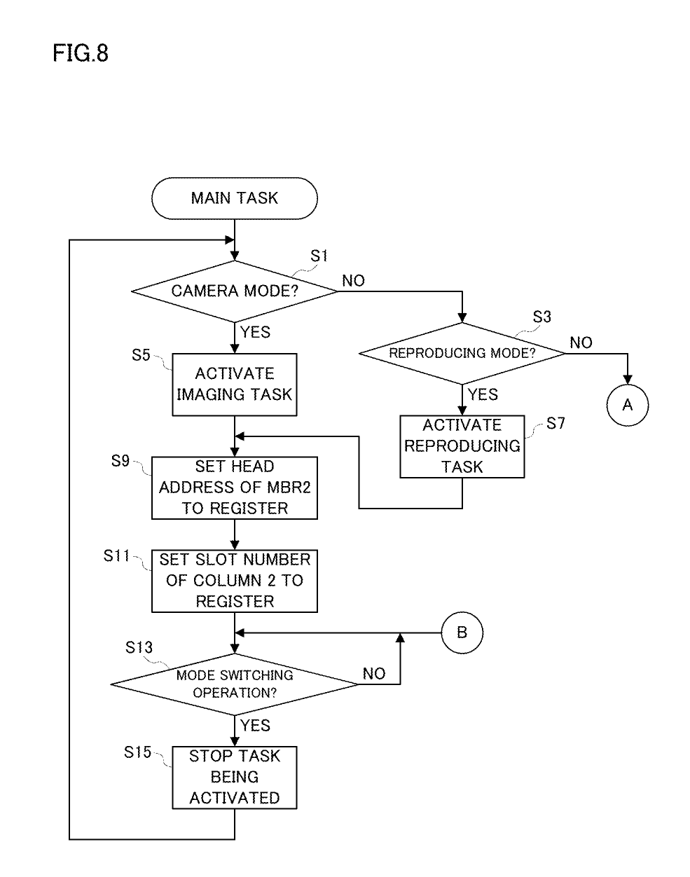

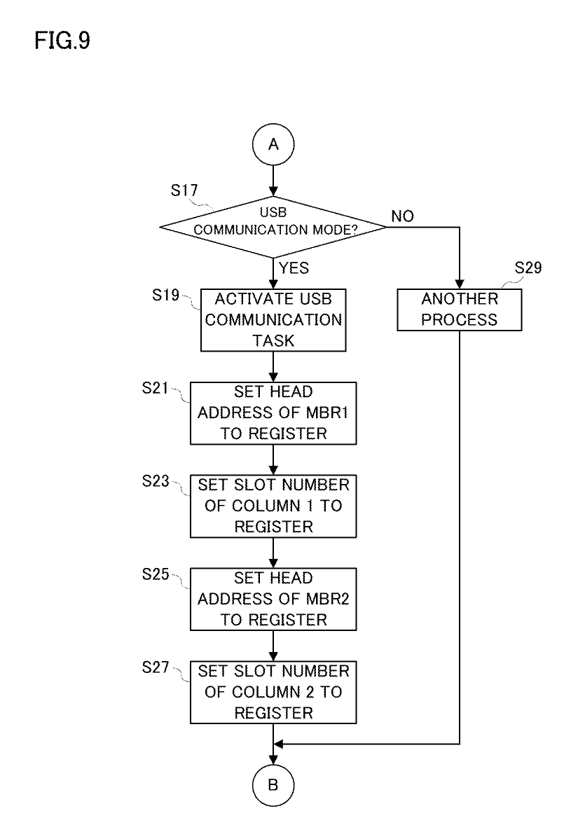

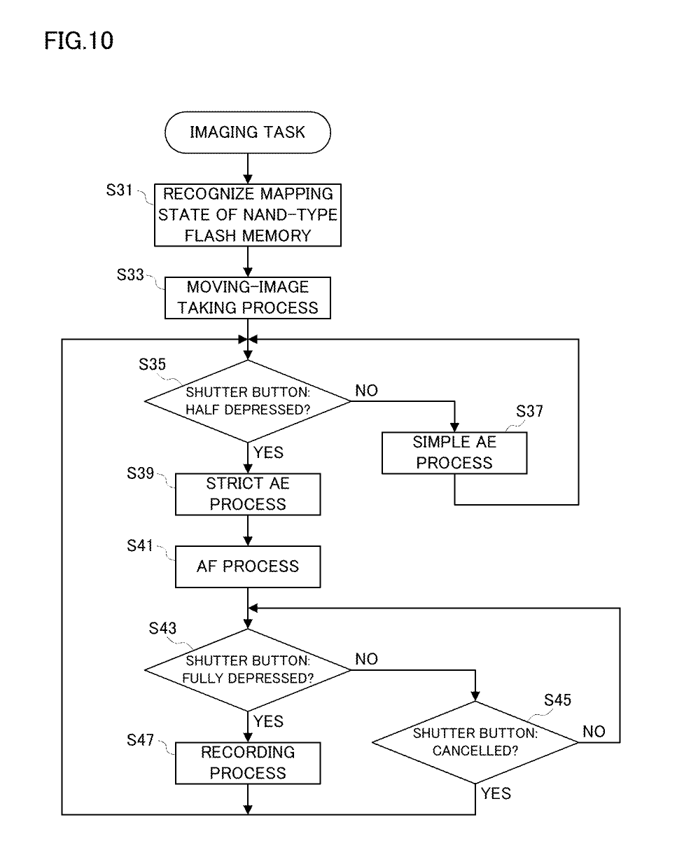

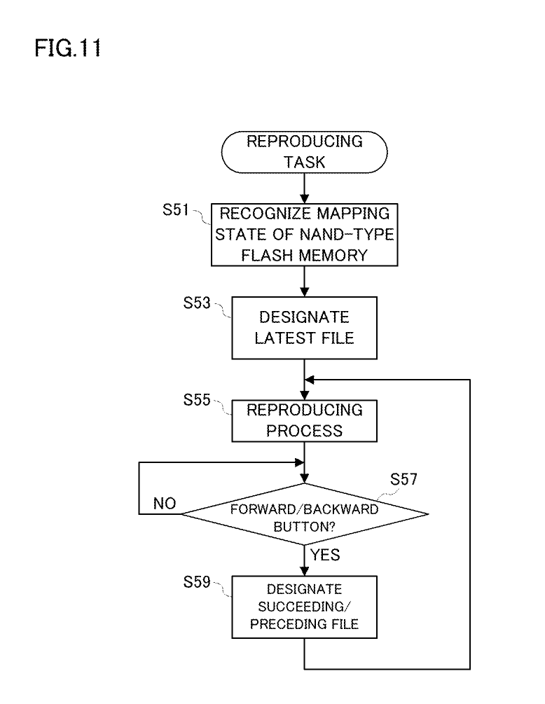

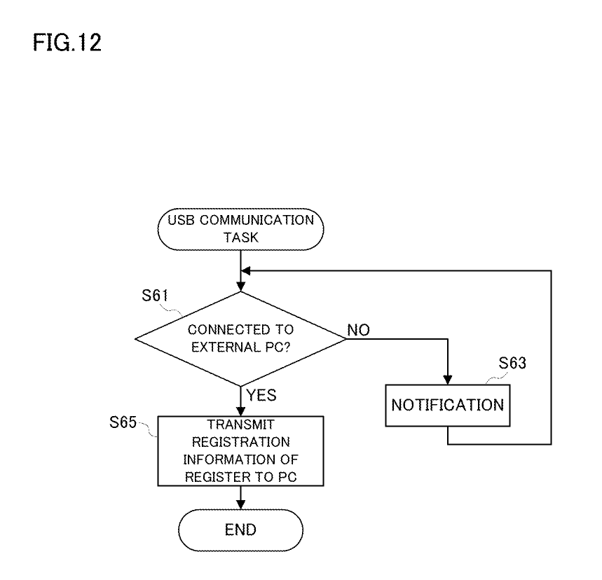

The CPU 30 executes the main task shown in FIG. 8 and FIG. 9 irrespective of the operation mode, and also executes following tasks: the imaging task shown in FIG. 10 is executed when the camera mode is selected; the reproducing task shown in FIG. 11 is executed when the reproducing mode is selected; and the USB communication task shown in FIG. 12 is executed when the USB communication mode is selected.

With reference to FIG. 8, in a step Sa, it is determined whether or not an operation mode at a current time point is the camera mode, and in a step S3, it is determined whether or not an operation mode at a current time point is the reproducing mode. Moreover, in a step S17, it is determined whether or not an operation mode at a current time point is the USB communication mode.

When YES is determined in the step S1, the imaging task is activated in a step S5, and when YES is determined in the step S3, the reproducing task is activated in a step S7. Upon completion of the process in the step S5 or S7, the process advances to a step S9 so as to set a head address of the MBR 2 to the column 1 of the register RGST1 as an effective MBR address. In a step S11, a slot number described in the column 2 of the partition table is set to the column 1 of the register RGST1 as an effective slot number.

In a step S13, it is determined whether or not a mode switching operation is performed, and when a determined result is updated from NO to YES, the task that is being activated is stopped in a step S15. Upon completion of a stopping process, the process returns to the step S1.

When YES is determined in the step S17, the USB communication task is activated in a step S19. In a step S21, a head address of the MBR 1 is set to the column 1 of the register RGST1 as the effective MBR address, and in a step S23, a slot number described in the column 1 of the partition table is set to the column 1 of the register RGST1 as the effective slot number.

In a step S25, the head address of the MBR 2 is set to the column 2 of the register RGST1 as the effective MBR address, and in a step S27, a slot number described in the column 2 of the partition table is set to the column 2 of the register RGST1 as the effective slot number. Upon completion of the process in the step S27, the process advances to the step S13. It is noted that, when an operation mode at a current time point is not any of the camera mode, the reproducing mode and the USB communication mode, another process is executed in a step S29, and thereafter, the process advances to the step S15.

With reference to FIG. 10, in a step S31, a mapping state of the flash memory 36 is recognized with reference to the register RGST1 which is set as shown in FIG. 4(A). As a result, the flash memory 36 is recognized as having a mapping shown in FIG. 4(A). In a step S33, the moving-image taking process is executed. As a result, a live view image representing a scene captured on the imaging surface is displayed on the LCD monitor 28. In a step S35, it is determined whether or not the shutter button 32sh is half depressed, and as long as a determined result is NO, the simple AE process in a step S37 is repeated. As a result, a brightness of the live view image is adjusted approximately.

When the shutter button 32sh is half depressed, the strict AE process is executed in a step S39, and the AF process is executed in a step S41. As a result, the brightness and sharpness of the live view image are adjusted strictly. In a step S43, it is determined whether or not the shutter button 32sh is fully depressed, and in a step S45, it is determined whether or not the operation of the shutter button 32sh is cancelled.

When YES is determined in the step S45, the process directly returns to the step S35. Moreover, when YES is determined in the step S43, the recording process is executed in a step S47. As a result, an image file containing image data at a time point at which the shutter button 32sh is fully depressed is newly written into the data area 2 of the flash memory 36, attribute information of a new image file is described in the directory entry 2, and the FAT 2 is updated so that a link is formed among a plurality of clusters in which the new image file is written. Upon completion of the recording process, the process returns to the step S35.

With reference to FIG. 11, in a step S51, the mapping state of the flash memory 36 is recognized with reference to the register RGST1 which is set as shown in FIG. 4(A). As a result, the flash memory 36 is recognized as having the mapping shown in FIG. 5(A). In a step S53, the latest image file on the data area 2 is detected with reference to a description of the directory entry 2 so as to designate the detected image file as a reproduction file. In a step S55, the memory I/F 34 and the LCD driver 26 are commanded to execute the reproducing process in which the designated image file is noticed.

The I/F 34 reads out image data stored in the designated image file from the data area 2 with reference to the FAT 2, and writes the read-out image data into the SDRAM 24 through the memory control circuit 22. The LCD driver 26 reads out the image data stored in the SDRAM 24, through the memory control circuit 22, and drives the LCD monitor 28 based on the read-out image data. As a result, a reproduced image is displayed on the LCD monitor 28.

In a step S57, it is determined whether or not the image forward/backward button 32fr is operated. When a determined result is updated from NO to YES, the process advances to a step S59 so as to designate a succeeding image file or a preceding image file with reference to the directory entry 2. Upon completion of the designating process, the process returns to the step S55. As a result, another reproduced image is displayed on the LCD monitor 28.

With reference to FIG. 12, in a step S61, it is determined whether or not the digital camera 10 and the external personal computer 50 are connected to each other by the USB cable CBL1. When a determined result is NO, a predetermined notification is outputted in a step S63, and thereafter, the process returns to the step S61. When the determined result is YES, the process advances to a step S65 so as to transfer registration information of the register RGST1 to the external personal computer 50 through the USB device 40. The USB communication task is ended after completion of transferring.

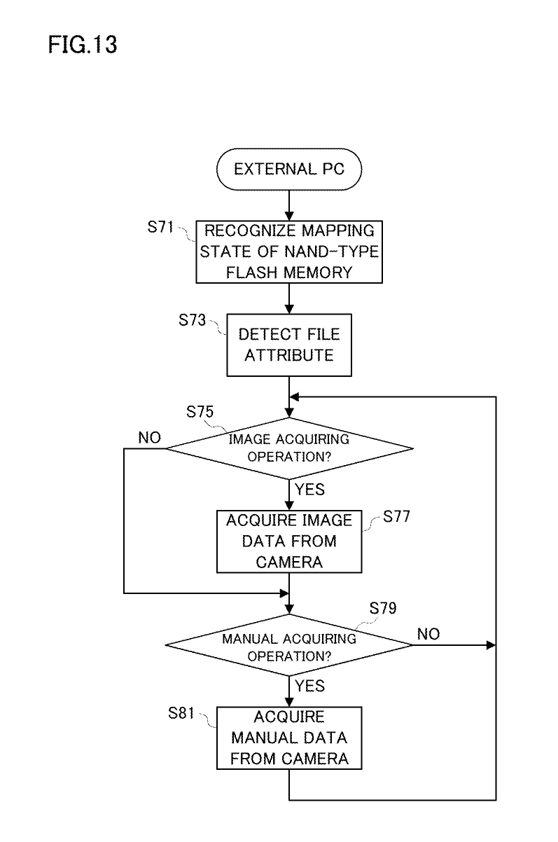

The CPU 58 arranged in the external personal computer 50 executes processes according to a flowchart shown in FIG. 13. It is noted that a control program corresponding to the flowchart is stored in an HDD 66.

In a step S71, the mapping state of the flash memory 36 is recognized with reference to the registration information of the register RGST1 transferred from the digital camera 10. As a result, the flash memory 36 is recognized as having a mapping shown in FIG. 5(B).

In a step S73, a corresponding command is issued toward the digital camera 10 in order to detect an attribute of the file stored in each of the slots 1 and 2. In contrary, the attribute information sent back from the digital camera 10 is written into the DRAM 56 by the memory control circuit 54. The icons IC1 and IC2 corresponding to thus acquired attribute information are displayed on the display monitor 62 as shown in FIG. 7.

In a step S75, it is determined whether or not the image acquiring operation (clicking the icon IC2) is performed, and in a step S79, it is determined whether or not the manual acquiring operation (clicking the icon IC1) is performed.

When a determined result of the step S75 is YES, a corresponding command is issued toward the digital camera 10 in order to acquire image data corresponding to the clicked icon IC2 from the flash memory 36. In contrary, the image data sent back from the digital camera 10 is written into the DRAM 56 by the memory control circuit 54. An image based on the image data thus acquired is displayed on the display driver 60.

When a determined result of the step S79 is YES, a corresponding command is issued toward the digital camera 10 in order to acquire the operation manual data. The operation manual data sent back from the digital camera 10 is written into the DRAM 56 by the memory control circuit 54. An operation manual based on the operation manual data thus acquired is displayed on the display driver 60.

As can be seen from the above-described explanation, the memory I/F 34 accesses the flash memory 36 in which the slots 1 and 2 are formed. The operation mode is switched by the mode selector switch 28sw among the camera mode (an image recording mode), the reproducing mode (an image reproducing mode) and the USB communication mode (a manual reading-out mode). The CPU 30 designates at least one of the slots 1 and 2 in a manner different depending on the operation mode selected by the mode selector switch 28sw (S9 to S11, S21 to S27). When the selected operation mode is the camera mode or the reproducing mode, the CPU 30 controls a processing operation of the memory I/F 34 with reference to identification information (the head address of the MBR and the slot number) of the designated slot (S31, S47, S51 and S55). On the other hand, when the selected operation mode is the USB communication mode, the CPU 30 sends the identification information of the designated slot in order for the external personal computer 50 to refer (S65).

A designating manner of the slots 1 and 2 formed in the flash memory 36, by extension, data or information read out from the flash memory 36 is different depending on when the camera mode or the reproducing mode is selected or when the USB communication mode is selected. Thereby, it becomes possible to improve a diversity of the data or the information to be contained in the flash memory 36.

Moreover, the identification information of the designated slot is referred to by the internal memory I/F 34 when the camera mode or the reproducing mode is selected whereas is sent in order for the external personal computer 50 to refer, when the USB communication mode is selected. Thereby, it becomes possible to reduce a load imposed on an access process under the USB communication mode.

Furthermore, in this embodiment, the slot 1 which manages the operation manual is arranged in the position adjacent to the firmware. Thereby, it becomes possible to write the IPL, the boot program, the firmware and the slot 1 into the flash memory 36 at a time by using a ROM writer, and as a result, it becomes possible to shorten a time required for manufacturing.

It is noted that the digital camera is assumed in this embodiment, however, the present invention is possible to be adapted to any electronic devices which have a plurality of operation modes and access the recording medium. Moreover, in this embodiment, the program and the data are stored together in the NAND-type flash memory 36, however, the program and the data may be dispersively stored in the NOR-type flash memory and the NAND-type flash memory.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An access control apparatus, comprising:
an accessor which accesses a recording medium in which a plurality of partitions are formed;
a selector which selects any one of a first mode and a second mode;
a designator which designates at least a part of the plurality of partitions in a manner different depending on a mode selected by said selector;
a controller which controls a processing operation of said accessor with reference to identification information of the partition designated by said designator, when the mode selected by said selector is the first mode; and
a sender which sends the identification information of the partition designated by said designator in order for an external device to refer, when the mode selected by said selector is the second mode.

2. An access control apparatus according to claim 1, wherein each of the plurality of partitions has a boot record, and said controller includes a recognizer which recognizes a mapping state of said recording medium based on a boot record of a partition identified by the identification information.

3. An access control apparatus according to claim 1, wherein said designator registers on a register identification information of a partition to be designated, and each of said accessor and said sender executes a process with reference to said register.

4. An access control apparatus according to claim 1, wherein the plurality of partitions include a first partition which stores image data, and the first mode includes an image recording/reproducing mode.

5. An access control apparatus according to claim 1, wherein the plurality of partitions include a second partition which stores operation manual data, and the second mode includes a manual readout mode.

6. An access control apparatus according to claim 5, wherein said recording medium stores firmware, and the second partition is formed in a position adjacent to the firmware.

7. An access control program recorded on a non-transitory recording medium in order to control an access control apparatus provided with an accessor which accesses a recording medium in which a plurality of partitions are formed and a selector which selects any one of a first mode and a second mode, the program causing a processor of the access control apparatus to perform the steps comprising:
a designating step of designating at least a part of the plurality of partitions in a manner different depending on a mode selected by said selector;
a controlling step of controlling a processing operation of said accessor with reference to identification information of the partition designated by said designating step, when the mode selected by said selector is the first mode; and
a sending step of sending the identification information of the partition designated by said designating step in order for an external device to refer, when the mode selected by said selector is the second mode.

8. An access control method executed by an access control apparatus provided with an accessor which accesses a recording medium in which a plurality of partitions are formed and a selector which selects any one of a first mode and a second mode, comprising:
a designating step of designating at least a part of the plurality of partitions in a manner different depending on a mode selected by said selector;
a controlling step of controlling a processing operation of said accessor with reference to identification information of the partition designated by said designating step, when the mode selected by said selector is the first mode; and
a sending step of sending the identification information of the partition designated by said designating step in order for an external device to refer, when the mode selected by said selector is the second mode.
